(19) United States
(12) Patent Application Publication
(10) Pub. No.: US 2019/0170924 A1
(43) Pub. Date: Jun. 6, 2019

(54) BACKLIGHT UNIT HAVING A LIGHT GUIDE PLATE WITH A PATTERNED CAPPING LAYER AND DISPLAY DEVICE INCLUDING THE SAME

(71) Applicant: SAMSUNG DISPLAY CO., LTD., YONGIN-SI (KR)

(72) Inventor: JEONG MIN SEO, YONG IN-SI (KR)

(21) Appl. No.: 16/165,522

(22) Filed: Oct. 19, 2018

(30) Foreign Application Priority Data
Dec. 4, 2017 (KR) 10-2017-0164930

(51) Int. Cl. F21V 8/00

(52) U.S. Cl. CPC G02B 6/005

(57) ABSTRACT

A backlight unit includes a light guide plate and a wavelength conversion layer disposed on a surface of the light guide plate. The wavelength conversion layer is configured to convert a color of incident light. The wavelength conversion layer includes an emboss pattern thereon. The emboss pattern includes a plurality of peak portions and a plurality of valley portions. The plurality of peak portions includes a first peak portion, a second peak portion proximate to the first peak portion in a first direction, and a third peak portion proximate to the first peak portion in a second direction. The plurality of valley portions includes a first valley portion disposed between the second peak portion and the third peak portion.

This application claims priority to Korean Patent Application No. 10-2017-0164930, filed on Dec. 4, 2017 in the Korean Intellectual Property Office, under 35 U.S.C. § 119, the disclosure of which is herein incorporated by reference in its entirety.

### TECHNICAL FIELD

The present disclosure relates to a backlight unit and, more specifically, to a backlight unit having a light guide plate with a patterned capping layer and a display device including the same.

### DISCUSSION OF THE RELATED ART

A variety of display devices such as liquid-crystal display (LCD) devices and organic light-emitting diode display (OLED) devices are currently being developed to satisfy a demand for multimedia devices.

For example, a liquid-crystal display device may include a liquid-crystal display panel with field generating electrodes such as pixel electrodes and a common electrode, and a liquid-crystal layer in which an electric field is formed by the field generating electrodes. A backlight unit may provide light to the liquid-crystal display panel. The liquid-crystal display device displays images by re-aligning liquid crystals in the liquid-crystal layer by using the electric field generating electrodes to thereby control the amount of light passing through the liquid-crystal layer for each pixel.

As display devices find a variety of applications, demands on curved display devices are increasing. Curved display devices may have a curved screen to provide viewers with a more immersive viewing experience.

### SUMMARY

A backlight unit includes a light guide plate and a wavelength conversion layer disposed on a surface of the light guide plate. The wavelength conversion layer is configured to convert a color of incident light. The wavelength conversion layer includes an emboss pattern thereon. The emboss pattern includes a plurality of peak portions and a plurality of valley portions. The plurality of peak portions includes a first peak portion, a second peak portion proximate to the first peak portion in a first direction, and a third peak portion proximate to the first peak portion in a second direction. The plurality of valley portions includes a first valley portion disposed between the second peak portion and the third peak portion.

A display device includes a light guide plate. A wavelength conversion layer is disposed on a surface of the light guide plate and is configured to convert a color of incident light. The wavelength conversion layer includes an emboss pattern having a plurality of peak portions and a plurality of valley portions. A display panel is disposed on the wavelength conversion layer. The plurality of peak portions includes a first peak portion, a second peak portion proximate to the first peak portion in a first direction, and a third peak portion proximate to the first peak portion in a second direction. The plurality of valley portions includes a first valley portion disposed between the second peak portion and the third peak portion.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is an exploded, perspective view illustrating a display device according to an exemplary embodiment of the present disclosure;

FIG. 2 is a cross-sectional view taken along line II-II′ in FIG. 1;

FIG. 3 is an enlarged, perspective view of the backlight unit of FIG. 1;

FIG. 4 is a cross-sectional view taken along line IV-IV′ of FIG. 3;

FIG. 5 is a cross-sectional view taken along line V-V′ of FIG. 3;

FIG. 6 is a cross-sectional view taken along line VI-VI′ of FIG. 3;

FIG. 7 is a cross-sectional view of a display device according to an exemplary embodiment of the present disclosure;

FIG. 8 is an exploded perspective view of a display device according to an exemplary embodiment of the present disclosure;

FIG. 9 is a cross-sectional view taken along line IX-IX′ of FIG. 8;

FIG. 10 is an enlarged, perspective view of the backlight unit of FIG. 8;

FIG. 11 is a cross-sectional view taken along line XI-XI′ of FIG. 10;

FIG. 12 is a cross-sectional view taken along line XII-XII′ of FIG. 10; and

FIG. 13 is a cross-sectional view taken along line XIII-XIII′ of FIG. 10.

### DETAILED DESCRIPTION OF THE EMBODIMENTS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner .

It will be understood that when an element or layer is referred to as being “on,” “connected to” or “coupled to” another element or layer, the element or layer can be directly on, connected or coupled to another element or layer or intervening elements or layers. As used herein, connected may refer to elements being physically, electrically and/or fluidly connected to each other.

Like numbers may refer to like elements throughout the specification and the drawings.

It will be understood that, although the terms first, second, third, etc., may be used herein to describe various elements, components, regions, layers and/or sections, these elements, components, regions, layers and/or sections may be otherwise enumerated. These terms are used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures.

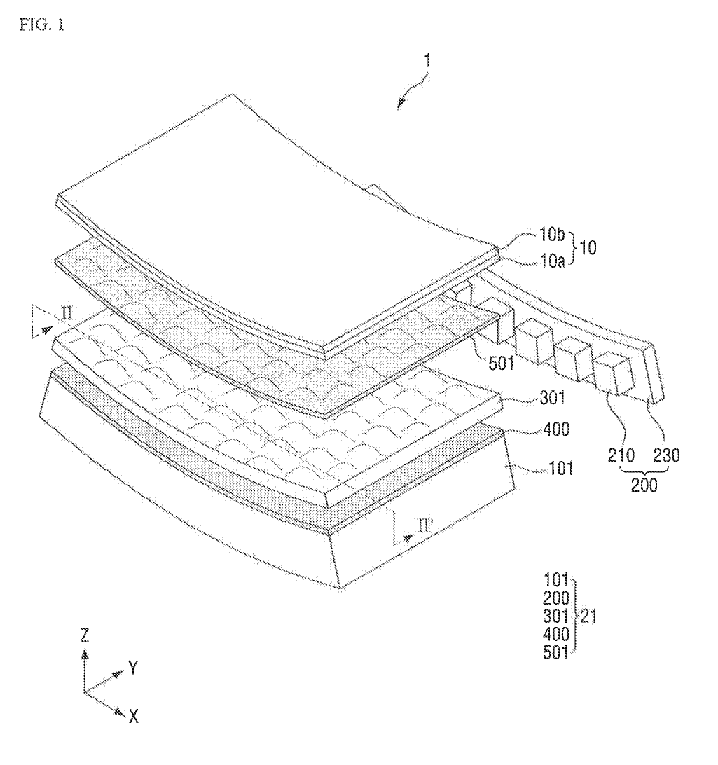

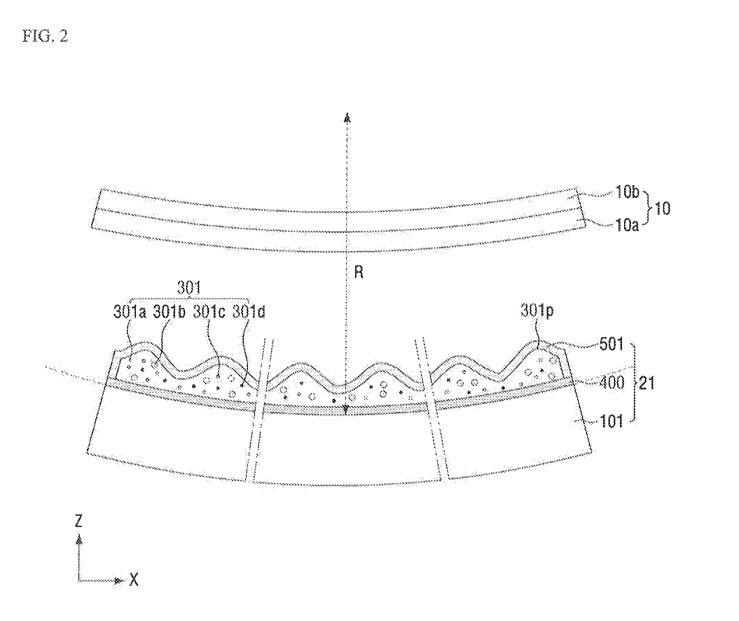

FIG. 1 is an exploded, perspective view illustrating a display device according to an exemplary embodiment of the present disclosure. FIG. 2 is a cross-sectional view taken along line II-II′ in FIG. 1.

Referring to FIGS. 1 and 2, a display device 1 according to an exemplary embodiment of the present disclosure includes a display panel 10 and a backlight unit 21 for providing light to the display panel 10.

The display panel 10 may be a panel-type member including elements used by the display device 1 to display an image. A plurality of pixels may be defined in the display panel 10. The plurality of pixels may be arranged as a matrix of rows and columns. As used herein, a “pixel” refers to a smallest independent unit of image display. Each single pixel may display a predetermined one of a set of primary colors. For example, a single pixel may be a minimum unit that can represent a color independently of another pixel.

The display panel 10 may have a generally rectangular shape when viewed from the top with a pair of longer sides and a pair of shorter sides. For example, the longer sides of the display panel 10 may generally extend in the first direction X, and the shorter sides thereof may generally extend in the second direction Y. The drawings, the corners of the display panel DP may be right angles or may be chamfered or rounded.

In an exemplary embodiment of the present disclosure, the display panel 10 may be a liquid-crystal display panel including a bottom plate 10a, a top plate 10b, and a liquid-crystal layer interposed therebetween. However, to be understood that the display panel 10 may have other arrangements. The display panel 10 may be any other display panel requiring a backlight unit for image display. In some exemplary embodiments of the present invention, the display panel 10 may be at least partially bent in the first direction X, and the display device 1 may be a curved display device. According to an exemplary embodiment of the present invention, the display panel 10 may be bent in the first direction X and/or the second direction Y. As used herein, a phrase “an element is bent in a direction or along a direction” means that the slope of a surface of the element varies along the direction so that the surface forms a curved surface. For example, when the element bent in a particular direction is cut along the particular direction, the cross section becomes a curved surface.

The backlight unit 21 may be disposed such that it at least partially overlaps with the display panel 10 in a third direction Z and the backlight 21 may be configured to emit light having a particular wavelength in a direction toward the display panel 10. For example, the backlight unit 21 may emit white light including red light, green light, and blue light. When the display device 1 is a curved display device, the backlight unit 21 may be, but need not be, disposed above the convex surface of the display panel 10.

In an exemplary embodiment of the present disclosure, the backlight unit 21 may include a light guide plate 101, a light source unit 200 disposed on the side of the light guide plate 101 where light is incident, and a wavelength conversion layer 301 disposed on the side of the light guide plate 101 where light exits.

The light guide plate 101 may guide the light provided from the light source unit 200 so that the light exits toward the display panel 10. For example, one side surface of the light guide plate 101 that faces the light source unit 200 defines a light-incidence face, and the top surface of the light guide plate 101 facing the display panel 10 defines a light-exiting face.

The light guide plate may include a material having a high light transmittance so as to be at least partially transparent. For example, it may include a glass material, a quartz material, or a polymer material such as polyethylene terephthalate, polymethyl methacrylate and/or polycarbonate.

The light guide plate 101 may be at least partly bent in the first direction X so that the top surface of the light guide plate 101 may form a concave surface. For example, in the cross section taken along the bending direction of the light guide plate 101 (e.g., the first direction X), the top surface of the light guide plate 101 may form a part of an arc, or a part of an elliptical arc. The radius of curvature R of the light guide plate 101 bent in the first direction X may be, but toned not be, within a range of approximately 1,500 mm to 5,000 mm. According to an exemplary embodiment of the present invention, the light guide plate 101 may be bent in both the first direction X and the second direction Y.

To facilitate the exit of the light traveling within the light guide plate 101 with total reflection, a negative or positive optical pattern may be formed on the convex back surface (shown as the lower surface in FIG. 2) of the light guide plate 101. Alternatively, a pattern for facilitating the exit of the light may be further disposed on the back surface of the light guide plate 101.

The light source unit 200 may be disposed above the light-incidence face of the light guide plate 101. According to an exemplary embodiment of the present disclosure where the light guide plate 101 is at least partially bent in the first direction X, the light source unit 200 may be disposed on a side of the light guide plate 101 in the second direction Y perpendicular to the first direction X, and the back light unit 21 may be an edge-lit backlight unit. For example, one of the side surfaces of the light guide plate 101 in the second direction Y may be the light incidence-face. The side surface of the light guide plate 101 on one side in the second direction Y and the side surface on the other side in the second direction Y may be substantially parallel. For example, the side surface of the light guide plate 101 on one side in the first direction X and the side surface of the light guide plate 101 on the other side in the first direction X might not be parallel to each other.

The light source unit 200 may include light sources 210 that emit light, and a light source circuit board 230.

The light sources 210 may be light-emitting diodes (LEDs), organic light-emitting diodes (OLEDs), laser diodes (LDs), or the like. For example, each of the light sources 210 may include a light-emitting diode chip configured to generate and emit light. The light source 210 may emit blue light having a peak wavelength in the range of approximately 430 nm to 480 nm or may emit light in the ultraviolet wavelength band. The light sources 210 may be disposed on the mounting surface of the light source circuit board 230 and may be spaced apart from one another along the first direction X.

The light source circuit board 230 may supply various signals and power for driving the light sources 210 and may further provide a space for mounting the light sources 210. For example, the light source circuit board 230 may be a printed circuit board (PCB). The light sources 210 may be mounted on one of the side surfaces of the light source circuit board 230. The side surface of the light source circuit board 230 on which the light sources 210 are mounted defines the mounting surface. The mounting surface of the light source circuit board 230 may face the light incidence-face of the light guide plate 101.

The light source circuit board 230 may be extended generally in the first direction X and may have a shape conforming to the light-incidence face of the light guide plate 101. For example, the light source circuit board 230 may be at least partially bent in the first direction X. For example, the top surface of the light source circuit board 230 may be at least partially bent in the first direction X, so that the top surface of the light source circuit board 230 may form a concave surface.

The wavelength conversion layer 301 may be disposed on the light guide plate 101. According to an exemplary embodiment of the present disclosure, the color conversion layer 301 may include a base resin 301a, and wavelength shifters 301b and 301c dispersed or dissolved within the base resin 301a. The color conversion layer 301 may further include scattering particles (scatterers) 301d dispersed within the base resin 301a. The wavelength conversion layer 301 may have a shape conforming to the light guide plate 101. For example, the wavelength conversion layer 301 may be at least partially bent in the first direction X.

The wavelength conversion layer 301 may convert the color of incident light so that the color of the transmitted light is at least partially different from that of the incident light. For example, the light, after passing through the wavelength conversion layer 301, may be converted into light of a certain wavelength band, such that the color of the light provided from the backlight unit 21 toward the display panel 10 can be controlled.

The base resin 301a may form the shape of the wavelength conversion layer 301. In addition, the base resin 301a may work as a dispersion base for the wavelength shifters 301b and 301c and the scatterers 301d. The base resin 301a may include various materials that may have high light transmittance and exhibits excellent dispersion characteristics for the wavelength shifters 301b and 301c and the scatters 301d. For example, the base resin 301a may be made of an organic material such as an epoxy resin, an acrylic resin, a cardo resin, and/or an imide resin.

The wavelength shifters 301b and 301c may convert or shift the peak wavelength of the incident light to another peak wavelength. The wavelength shifters 301b and 301c may have a particulate form (e.g. they may each be comprised substantially of individual particles). Examples of the wavelength shifters 301b and 301c may include quantum dots, quantum rods, and/or phosphors. For example, a quantum dot is a structure that can emit light of a particular color as an electron transition from conduction band to valence band. The quantum dot material may have a core-shell structure. The core may be a semiconductor nanocrystalline material. Examples of the core of the quantum dots may include, silicon (Si) nanocrystals, II-VI group compound nanocrystals, and III-V group compound nanocrystals, etc. but other materials may also be used. For example, the wavelength shifters 301b and 301c may each include a core made of cadmium selenide (CdSe), cadmium telluride (CdTe), cadmium sulfide (CdS) or indium phosphide (InP), and an outer shell made of zinc sulfide (ZnS).

In an exemplary embodiment of the present disclosure, the wavelength shifters 301b and 301c may include a first wavelength shifter 301b that emits red light having a single peak wavelength in a range of approximately 600 nm to 650 nm, and a second wavelength shifter 301c that emits green light having a single peak wavelength in a range of approximately 510 nm to 570 nm. The exiting light converted by the first wavelength shifter 301b and the second wavelength shifter 301c may have a narrow wavelength band around the peak wavelength, so that color purity and clarity can be increased. In some exemplary embodiments of the present disclosure, the wavelength shifters 301b and 301c may include only the first wavelength shifter 301b and the second wavelength shifter 301c.

According to an exemplary embodiment of the present disclosure in which the light sources 210 provide light in the blue wavelength band, the blue light guided through the light guide plate 101 may be incident on the wavelength conversion layer 301 through the light-exiting face (for example, the upper face) of the light guide plate 101. At least some of the blue light incident on the wavelength conversion layer 301 may be converted into red light by the first wavelength shifter 301b, at least some of the blue light may be converted into green light by the second wavelength shifter 301c, and at least some of the blue light may transmit through the base resin 301a and remain blue. In this manner, the blue light provided from the light sources 210 may transmit through the wavelength conversion layer 301 and then may be converted into white light that comprises light of the red wavelength band, the green wavelength band and the blue wavelength band. After having passed through the wavelength conversion layer 301, the white light may be provided toward the display panel 10.

The scatterers 301d may have a refractive index different from that of the base resin 301a and may form an optical interface with the base resin 301a. For example, the scatterers 301d may include light scattering particles. The material of the scatters 301d is not particularly limited as long as they can scatter at least a part of the transmitted light to modulate the light path. For example, the scatterers 301d may be metal oxide particles or organic particles. Examples of suitable metal oxides may include titanium oxide (TiO₂), zirconium oxide (ZrO₂), aluminum oxide (Al₂O₃), indium oxide (In₂O₃), zinc oxide (ZnO), tin oxide (SnO₂) and the like. The scatters 301d can scatter light in various directions regardless of the incidence angle without substantially changing the wavelength of the light passing through the wavelength conversion layer 301. By doing so, the length of the path in which the light passes through the wavelength conversion layer 301 can be increased, and the color conversion efficiency by the wavelength shifters 301b and 301c can be increased.

The wavelength conversion layer 301 may have an emboss pattern 301p such as a repeating set of raised mounds and/or recessed depressions. The wavelength conversion layer 301 and the emboss pattern 301p will be described in detail below.

According to some exemplary embodiments of the present disclosure, the backlight unit 21 may further include a low-refractive layer 400 and a capping layer 501.

The low-refractive layer 400 may be disposed between the light guide plate 101 and the wavelength conversion layer 301. For example, the low-refractive layer 400 may be in contact with the light guide plate 101 and the wavelength conversion layer 301. The top surface of the low-refractive layer 400 in contact with the wavelength conversion layer 301 and the bottom surface of the wavelength conversion layer 301 in contact with the low-refractive index layer 400 may be substantially flat. The thickness of the low-refractive layer 400 can be generally uniform. The thickness of the low-refractive layer 400 may be, but is not limited to, approximately 1.0 μm or less, approximately 0.5 μm or less, or approximately 0.1 μm or less.

The low-refractive layer 400 may have a refractive index smaller than that of the base resin 301a of the light guide plate 101 and that of the wavelength conversion layer 301. For example, the refractive index of the low-refractive layer 400 may be approximately 1.0 to 1.4, or approximately 1.2 to 1.3. The difference between the refractive index of the light guide plate 101 and the refractive index of the low-refractive index layer 400 may be approximately 0.2 or more. By disposing the low-refractive layer 400 having a relatively low refractive index directly on the light guide plate 101, it is possible to facilitate the total reflection between the light guide plate 101 and the low-refractive layer 400, and it is possible to increase the guiding efficiency of the light traveling in the light guide plate 101.

The material of the low-refractive layer 400 may have a refractive index lower than that of the light guide plate 101 and that of the wavelength conversion layer 301. For example, the low-refractive layer 400 may include an inorganic layer including an inorganic material. Examples of suitable inorganic materials include silicon nitride, silicon oxide, silicon oxynitride and the like.

The capping layer 501 may be disposed on the wavelength conversion layer 301. The capping layer 501 can block impurities such as moisture or air from permeating into the wavelength conversion layer 301, which would otherwise damage the wavelength shifters 301b and 301c. The capping layer 501 may be an inorganic layer including silicon nitride, silicon oxide, or silicon oxynitride.

The capping layer 501 may be disposed directly on the wavelength conversion layer 301. The capping layer 501 may at least partially cover the side surfaces of the wavelength conversion layer 301 and may be partially in contact with the low-refractive layer 400 to encapsulate the wavelength conversion layer 301. When the top surface of the wavelength conversion layer 301 has the emboss pattern 301p, the capping layer 501 may have a shape conforming to the emboss pattern 301p. The thickness of the capping layer 501 may be generally uniform. The thickness of the capping layer 501 may be within the range of approximately 1.0 μm or less, approximately 0.5 μm or less, or approximately 0.1 μm or less. However, the capping layer 501 may alternatively have a thickness greater than 1.0 μm.

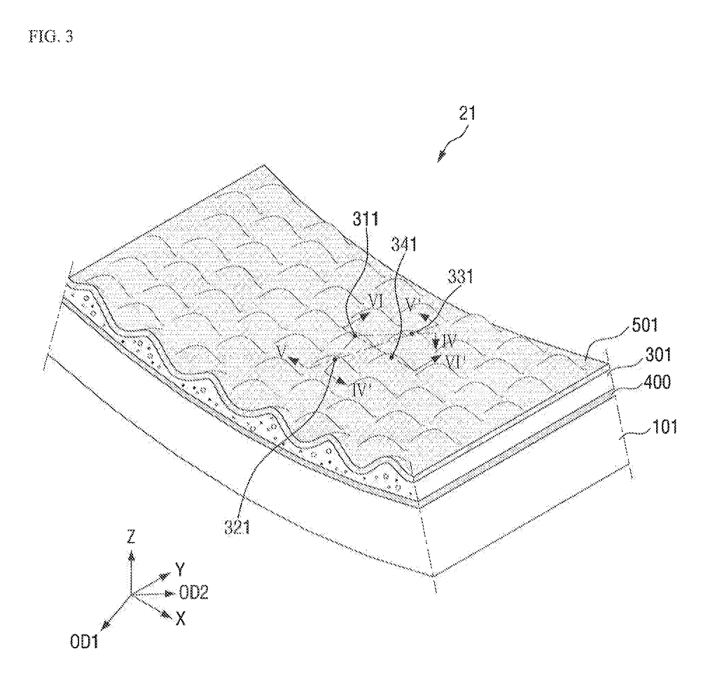

Hereinafter, referring to FIGS. 3 to 6, the wavelength conversion layer 301 according to an exemplary embodiment of the present disclosure will be described in detail.

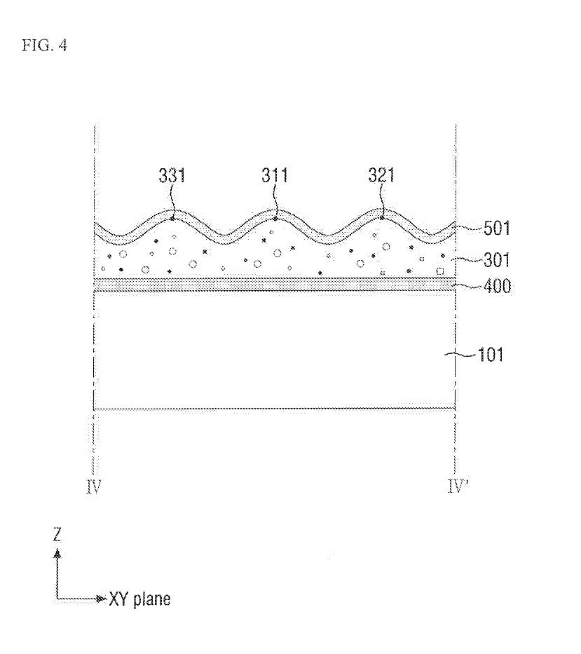

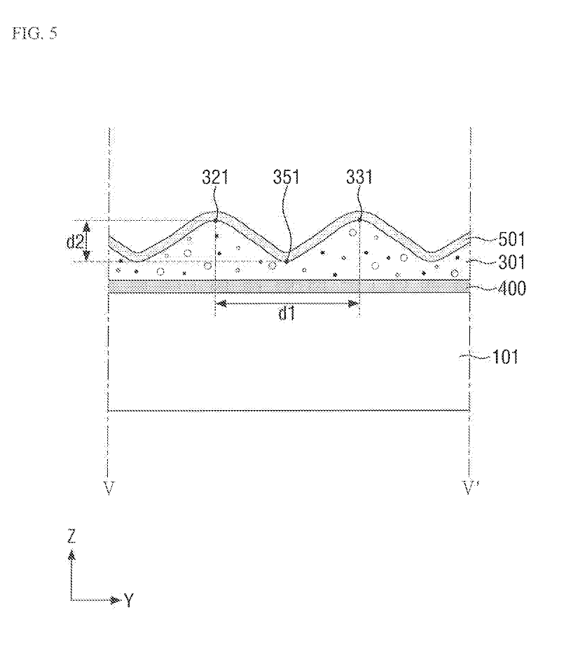

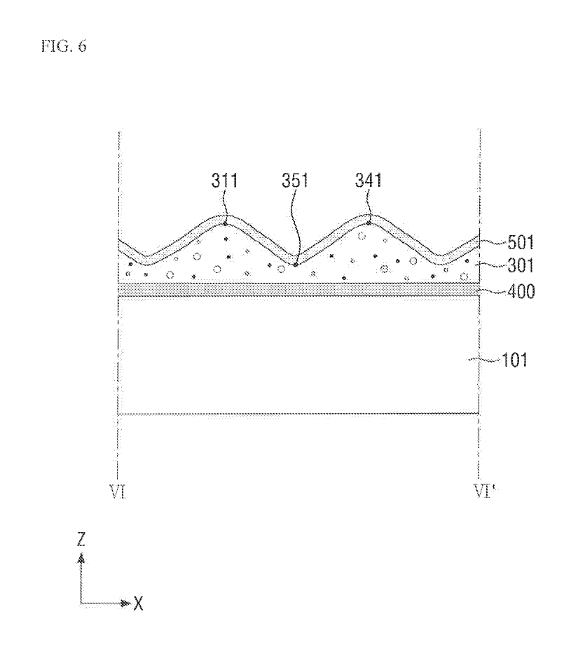

FIG. 3 is an enlarged, perspective view of the backlight unit of FIG. 1. FIG. 4 is a cross-sectional view taken along line IV-IV′ of FIG. 3, showing a first peak portion 311, a second peak portion 321 and a third peak portion 331 of FIG. 3. FIG. 5 is a cross-sectional view taken along line V-V′ of FIG. 3, showing the second peak portion 321 and the third peak portion 331 of FIG. 3. Specifically, FIG. 5 is a cross-sectional view of an example of the emboss pattern 301p cut along the second direction Y. FIG. 6 is a cross-sectional view taken along line VI-VI′ of FIG. 3, showing the first peak portion 311 and the fourth peak portion 341 of FIG. 3. Specifically, FIG. 6 is a cross-sectional view of the example of the emboss pattern 301p cut along the first direction X.

Referring to FIGS. 1 to 6, the top surface of the wavelength conversion layer 301 may have the emboss pattern 301p. For example, the top surface of the wavelength conversion layer 301 may have the emboss pattern 301p with a plurality of peak portions 311, 321, 331 and 341 and a plurality of valley portions 351 defined therein. As used herein, a “peak portion” refers to the height part around a given area, and a “valley portion” refers to the lowest part around a given area. For example, each of the plurality of peak portions 311, 321, 331 and 341 may be a part where the thickness of the wavelength conversion layer 301 in the third direction Z is greatest around them (e.g. a local maximum). In addition, each of the plurality of valley portions 351 may be a part where the thickness of the wavelength conversion layer 301 in the third direction Z is smallest around them (e.g. a local minimum).

The peak portions 311, 321, 331 and 341 may each have a convex rounded surface. The optical interface formed by the top surface having the emboss pattern 301p of the wavelength conversion layer 301 can be reduced as each of the peak portions of the wavelength conversion layer 301 has a rounded surface. Accordingly, it is possible to suppress the optical path modulation characteristics, for example, condensing or dispersion characteristics, which are generated in the vicinity of each of the peak portions of the wavelength conversion layer 301. Furthermore, by using the emboss pattern 301p of the wavelength conversion layer 301 having rounded surfaces, it is possible to increase resistance to compressive stress or tensile stress generated by bending.

Each of the plurality of valley portions 351 may have a rounded concave surface. The optical interface formed by the top surface having the emboss pattern 301p of the wavelength conversion layer 301 can be reduced as each of the valley portions of the wavelength conversion layer 301 has a rounded surface. Accordingly, it is possible to suppress the optical path modulation characteristics, which are generated in the vicinity of each of the valley portions of the wavelength conversion layer 301. Furthermore, by using the emboss pattern 301p of the wavelength conversion layer 301 having rounded surfaces, it is possible to increase resistance to compressive stress or tensile stress generated by bending.

According to an exemplary embodiment of the present disclosure, the plurality of peak portions 311, 321, 331 and 341 may be arranged in a matrix and spaced apart from one another in both a first oblique direction OD1 and a second oblique direction OD2. In addition, the plurality of valley portions 351 may be arranged in a matrix and spaced apart from one another in both the first oblique direction OD1 and the second oblique direction OD2.

For example, the plurality of peak portions 311, 321, 331 and 341 may include a first peak portion 311 and a second peak portion 321 adjacent to the first peak portion 311 in the first oblique direction OD1. The height of the first peak portion 311 may be substantially equal to the height of the second peak portion 321. The plurality of peak portions 311, 321, 331 and 341 may further include a third peak portion 331 adjacent to the first peak portion 311 in the second oblique direction OD2. The first oblique direction OD1 may be perpendicular to the second oblique direction OD2, however, the first and second oblique direction OD1 and OD2 may alternatively meet at other angles.

A valley portion 351 may be disposed between the second peak portion 321 and the third peak portion 331. For example, in a cross section of the emboss pattern 301p cut along the second direction Y including the second peak portion 321 and the third peak portion 331, the valley portion 351 may be disposed between the second peak portion 321 and the third peak portion 331.

In some exemplary embodiments of the present disclosure, the horizontal spacing distance d1 between the second peak portion 321 and the third peak portion 331 may be equal to or greater than three times the vertical shortest distance d2 between one of the peak portions (e.g., the second peak portion 321) and the valley portion 351. For example, a pitch of the emboss pattern 301p in the horizontal direction may be equal to or greater than three times the height difference of the emboss pattern 301p in the height direction. In addition, the vertical shortest distance d2 between one of the peak portions (e.g., the second peak portion 321) and the valley portion 351 may range from approximately 1.0 μm to approximately 10.0 μm.

As the horizontal spacing distance d1 between the second peak portion 321 and the third peak portion 331 of the emboss pattern 301p is equal to or greater than three times the vertical shortest distance d2 between the second peak portion 321 and the valley portion 351, the angle of the sloped surface of the emboss pattern 301p can be sufficiently low. Accordingly, the optical path modulation characteristic generated by the emboss pattern 301p of the wavelength conversion layer 301 can be suppressed.

In some exemplary embodiments of the present disclosure, the plurality of peak portions 311, 321, 331 and 341 may further include a fourth peak portion 341 that is adjacent to the second peak portion 321 in the second oblique direction OD2 and adjacent to the third peak portion 331 in the first oblique direction OD1. In addition, a valley portion 351 may be disposed between the first peak portion 311 and the fourth peak portion 341. For example, in a cross section of the emboss pattern 301p cut along the second direction Y including the first peak portion 311 and the fourth peak portion 341, the valley portion 351 may be disposed between the first peak portion 311 and the fourth peak portion 341. The valley portion 351 disposed between the first peak portion 311 and the fourth peak portion 341 may be the same point as the valley portion 351 disposed between the second peak portion 321 and the third peak portion 331. In some exemplary embodiments of the present disclosure, the horizontal spacing distance between the first peak portion 311 and the fourth peak portion 341 may be substantially equal to the horizontal spacing distance d1 between the second peak portion 321 and the third peak portion 331. For example, when viewed from the top, the first peak portion 311, the second peak portion 321, the third peak portion 331 and the fourth peak portion 341 may be disposed at the corners of a quadrangle, respectively, and the valley portion 351 may be disposed around the center of the quadrangle.

For example, a compressive stress or a tensile stress may be applied to the wavelength conversion layer 301 and/or the capping layer 501 if the display device 1 is twisted due to an external impact, when a curved display device is produced, or if there is a difference in thermal compression or thermal expansion characteristics between the low-refractive layer 400 and the wavelength conversion layer 301.

In light of the above, according to exemplary embodiments of the present disclosure, the wavelength conversion layer 301 has the emboss pattern 301p, so that it can increase the stress resistance of the wavelength conversion layer 301 and/or the capping layer 501. For example, when compressive stress is applied to the top surface of the wavelength conversion layer 301 and the capping layer 501, the top surface of the wavelength conversion layer 301 can have a space for compression by virtue of the emboss pattern 301p, and thus it is possible to prevent the capping layer 501 from being separated from the wavelength conversion layer 501 or to suppress the occurrence of cracks in the capping layer 501. In addition, when compressive stress is applied to the top surface of the wavelength conversion layer 301 and the capping layer 501, the top surface of the wavelength conversion layer 301 can have a tensile margin by virtue of the emboss pattern 301p, and thus it is possible to suppress the occurrence of cracks in the wavelength conversion layer 301 and the capping layer 501.

In addition, as the emboss pattern 301p includes the plurality of peak portions 311, 321, 331 and 341 and the plurality of valley portions 351 spaced apart from one another in the first oblique direction OD1 and the second oblique direction OD2 to form a curved surface, the resistance to the bending stress in the bending direction (e.g., the first direction X) of the light guide plate 101 may be increased and also the resistance to the compressive stress or tensile stress in the second direction Y may be increased.

In addition, one of the valley portions 351 is formed between the first peak portion 311 and the second peak portion 321 adjacent to each other in the bending direction (e.g., the first direction X) of the light guide plate 101, so that the highest height difference of the emboss pattern 301p may be formed in the bending direction of the light guide plate 101. By doing so, it is possible to increase the resistance of the wavelength conversion layer 301 to the bending stress in the bending direction. For example, by arranging the plurality of peak portions 311, 321, 331 and 341 and the valley portions 351 such that they intersect with the bending direction of the light guide plate 101, a structure more robust to bending can be implemented.

Hereinafter, other exemplary embodiments of the present disclosure will be described. To the extent that a description of certain elements is omitted, it may be assumed that these elements are at least similar to corresponding elements that have already been described.

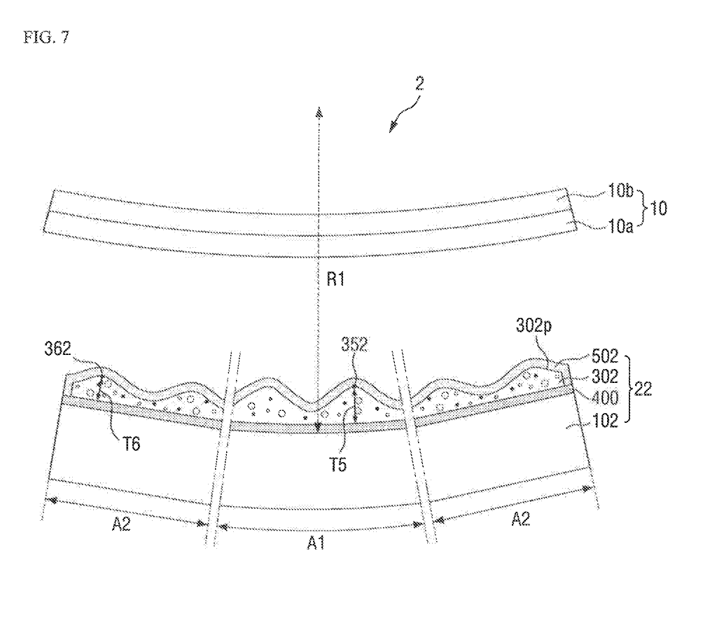

FIG. 7 is a cross-sectional view of a display device according to an exemplary embodiment of the present disclosure.

Referring to FIG. 7, the display device 2, according to an exemplary embodiment of the present disclosure, is different from the display device 1 shown in FIG. 2 in that the display device 2 includes a display panel 10 and a backlight unit 22, and a light guide plate 102 of the backlight unit 22 has partly different radii of curvature.

The light guide plate 102 may be at least partly bent in the first direction X so that the top surface of the light guide plate 102 may form a concave surface. According to an exemplary embodiment of the present invention, in a cross section cut along the bending direction of the light guide plate 102 (e.g., the first direction X), a top surface of a first area A1 disposed at the center of the light guide plate 102 may be bent at a first radius of curvature R1 to form a part of an arc, or a part of an elliptical arc. In addition, a top surface of a second area A2 disposed on a side of the first area A1 may have a second radius of curvature that is larger than the first radius of curvature R1 (e.g., indefinite radius of curvature). For example, according to an exemplary embodiment of the present disclosure, the center portion of the display device 2 including the light guide plate 102 may be bent at a predetermined curvature while the edges thereof may be flat with substantially no curvature. As an alternative to the arrangement shown in FIG. 7, the center portion of the display device 2 including the light guide plate 102 may be bent at a predetermined radius of curvature while the edges thereof may be bent at a smaller extent of curvature than that of the center portion (e.g., bent with a larger radius of curvature than that of the center portion).

The wavelength conversion layer 302 may be disposed on the light guide plate 102. The top surface of the wavelength conversion layer 302 may have an emboss pattern 302p. For example, the top surface of the wavelength conversion layer 302 may have the emboss pattern 302p with a plurality of peak portions 352 and 362, and a plurality of valley portions defined therein.

According to an exemplary embodiment of the present disclosure, the size of the emboss pattern 302p in the first area A1 of the light guide plate 102 may be larger than the size of the emboss pattern 302p in the second area A2 of the light guide plate 102. For example, the emboss pattern 302p may include a fifth peak portion 352 disposed in the first area A1 and a sixth peak portion 362 disposed in the second area A2. The thickness T5 of the wavelength converting layer 302 at the fifth peak portion 352 may be larger than the thickness T6 of the wavelength converting layer 302 at the sixth peak portion 362.

As described above, when the display device 2 is implemented as a curved display device, for example, compressive stress or tensile stress may be applied to the wavelength conversion layer 302 and the capping layer 502. In this case, the fifth peak portion 352 in the first area A1 bent at a relatively large curvature may be formed to have a sufficient size in the height direction, to thereby increase the resistance to compressive stress or tensile stress. On the other hand, the sixth peak portion 362 in the second area A2, which is substantially flat or bent with a smaller extent of curvature (larger radius of curvature), is formed to have a relatively small size in the height direction, so that the optical path modulation characteristic by the wavelength conversion layer 302 can be further suppressed.

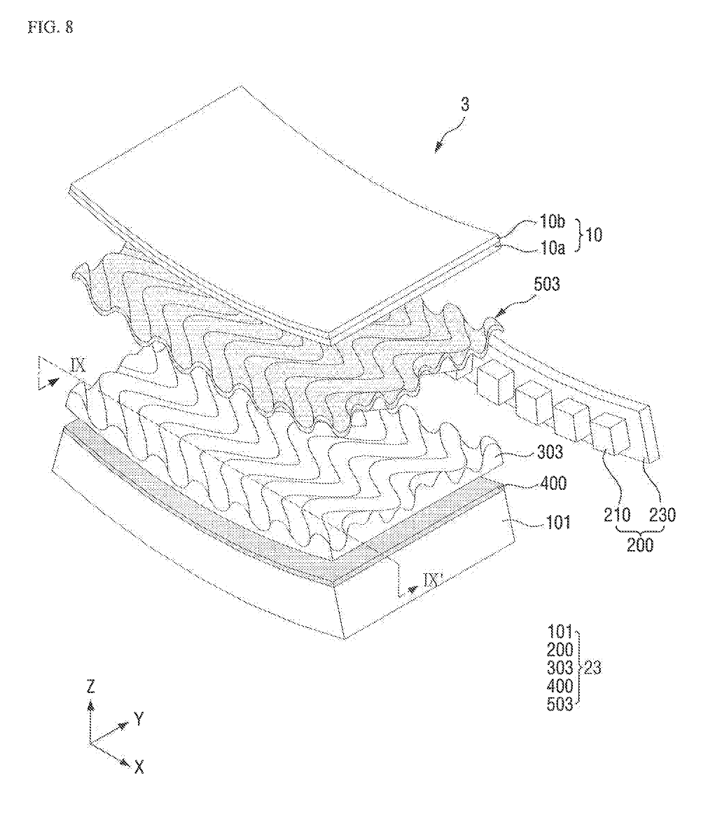

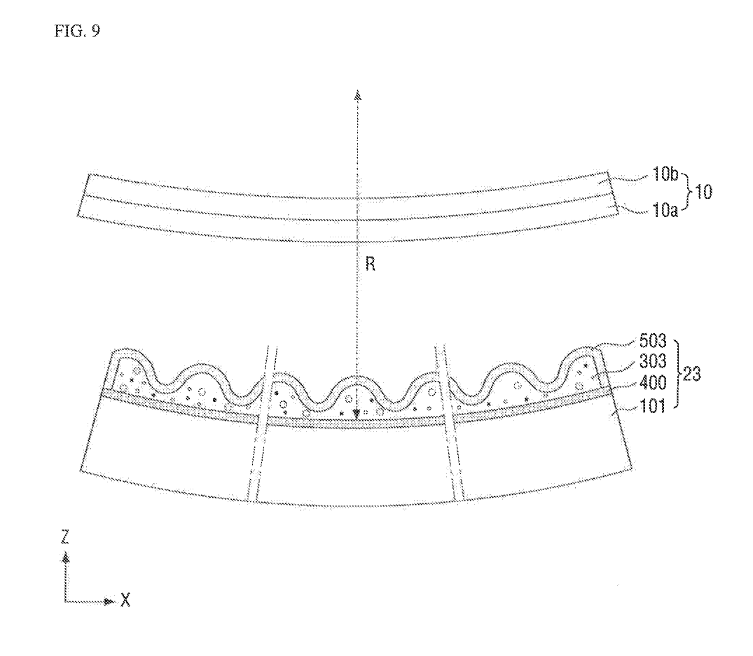

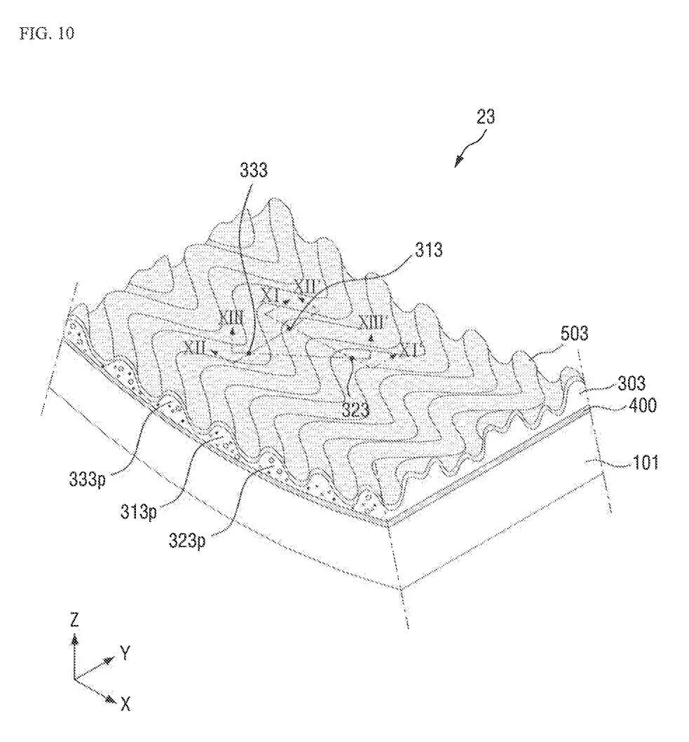

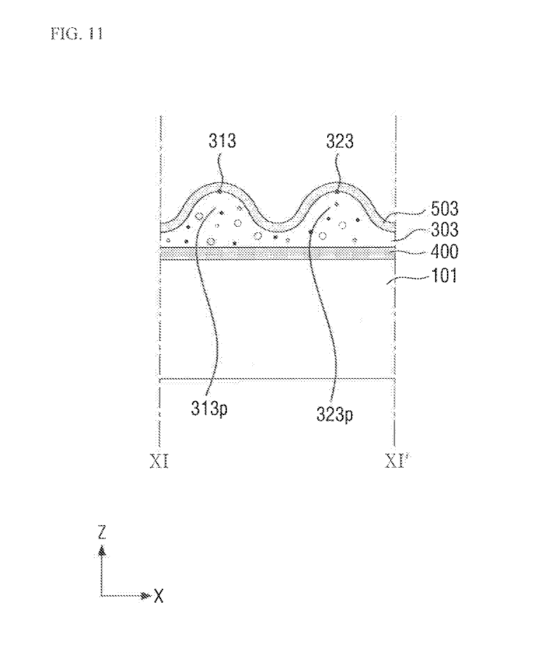

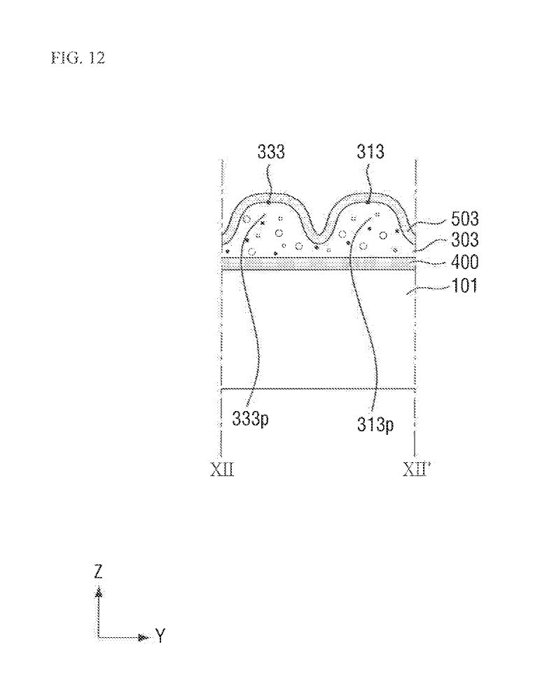

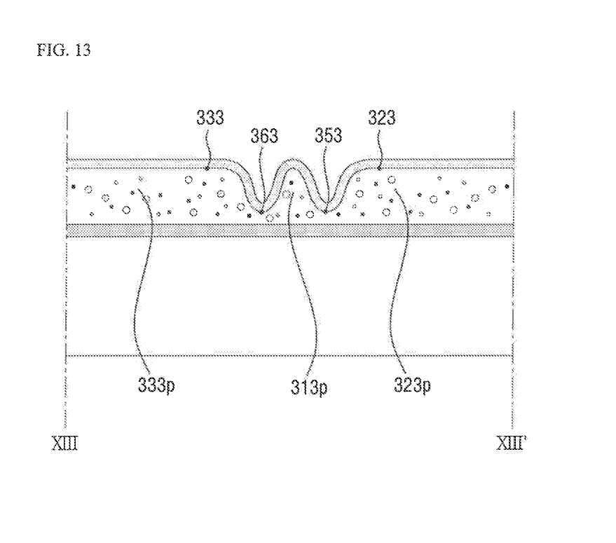

FIG. 8 is an exploded perspective view of a display device according to an exemplary embodiment of the present disclosure. FIG. 9 is a cross-sectional view taken along line IX-IX′ of FIG. 8. FIG. 10 is an enlarged, perspective view of the backlight unit of FIG. 8. FIG. 11 is a cross-sectional view taken along line XI-XI′ of FIG. 10, showing the first peak portion 313 and the second peak portion 323 of FIG. 10. Specifically, FIG. 11 is a cross-sectional view of the emboss pattern 303p cut along the first direction X. FIG. 12 is a cross-sectional view taken along line XII-XII′ of FIG. 10, showing the first peak portion 313 and the third peak portion 333 of FIG. 10. Specifically, FIG. 12 is a cross-sectional view of the emboss pattern 303p cut along the second direction Y. FIG. 13 is a cross-sectional view taken along line XIII-XIII′ of FIG. 10, showing the second peak portion 323 and the third peak portion 333 of FIG. 10.

Referring to FIGS. 8 to 13, a display device 3, according to an exemplary embodiment of the present disclosure, is different from the display device 1 shown in FIG. 2 in that the display device 3 includes a display panel 10 and a backlight unit 23, and an emboss pattern 303p of a wavelength conversion layer 303 of the backlight unit 23 is a linear pattern.

The top surface of the wavelength conversion layer 303 has an emboss pattern 303p in which a plurality of peak portions 313, 323 and 333 and a plurality of valley portions 353 and 363 are defined. The emboss pattern 303p may include a linear first emboss pattern 313p forming the first peak portion 313, a linear second emboss pattern 323p forming the second peak portion 323, and a linear third emboss pattern 333p forming the third peak portion 333.

The first emboss pattern 313p, the second emboss pattern 323p and the third emboss pattern 333p may each be extended generally in the second direction Y and may be spaced apart from one another in the first direction X. The first emboss pattern 313p, the second emboss pattern 323p and the third emboss pattern 333p may form the first peak portion 313, the second peak portion 323 and the third peak portion 333p, respectively, which protrude most in the height direction. Each of the plurality of peak portions 313, 323 and 333 may have a convex rounded surface.

Each of the first emboss pattern 313p, the second emboss pattern 323p and the third emboss pattern 333p may have a curved shape in the form of a wave propagating in the first direction X. The first emboss pattern 313p and the second emboss pattern 323p may partially overlap with each other in the second direction Y, and the first emboss pattern 313p and the third emboss pattern 333p may partially overlap with each other in the second direction Y.

As the first emboss pattern 313p, the second emboss pattern 323p and the third emboss pattern 333p, each of which has a curve shape in the form of a wave propagating in the bending direction (for example, the first direction X) of the light guide plate 103, partially overlap with one another in the extending direction (for example, the second direction Y), the resistance to compressive stress or tensile stress caused by bending may be improved.

A plurality of valley portions 353 and 363 may be formed between the first emboss pattern 313p and the second emboss pattern 323p and between the first emboss pattern 313p and the third emboss pattern 333p. Each of the plurality of valley portions 353 and 363 may have a rounded concave surface.

For example, in a cross-sectional view showing the second peak portion 323 of the second emboss pattern 323p and the third peak portion 333 of the third emboss pattern 333p, the first emboss pattern 313p, the first valley portion 353 and the second valley portion 363 may be disposed between the second peak portion 323 of the second emboss pattern 323p and the third peak portion 333 of the third emboss pattern 333p. The first valley portion 353 may be disposed between the first emboss pattern 313p and the second peak portion 323, and the second valley portion 363 may be disposed between the first emboss pattern 313p and the third peak portion 333.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A backlight unit comprising:
a light guide plate; and
a wavelength conversion layer disposed on a surface of the light guide plate, the wavelength conversion layer being configured to convert a color of incident light, the wavelength conversion layer comprising an emboss pattern thereon, the emboss pattern comprising a plurality of peak portions and a plurality of valley portions,
wherein the plurality of peak portions comprises:
a first peak portion;
a second peak portion proximate to the first peak portion in a first direction; and
a third peak portion proximate to the first peak portion in a second direction;
wherein the plurality of valley portions comprises a first valley portion disposed between the second peak portion and the third peak portion.

2. The backlight unit of claim 1, wherein each of the plurality of peak portions has a rounded and/or convex surface.

3. The backlight unit of claim 2, wherein each of the plurality of valley portions has a rounded and/or concave surface.

4. The backlight unit of claim 1, further comprising: a low-refractive layer disposed between the light guide plate and the wavelength conversion layer, wherein a refractive index of the low-refractive layer is smaller than that of the light guide plate and that of the wavelength conversion layer.

5. The backlight unit of claim 4, further comprising: a capping layer disposed directly on the wavelength conversion layer.

6. The backlight unit of claim 5, wherein the low-refractive layer is at least partially in contact with the capping layer.

7. The backlight unit of claim 6, wherein a lower surface of the wavelength conversion layer is in contact with the low-refractive layer and the lower surface of the wavelength conversion layer is substantially flat, and
wherein a top surface of the wavelength conversion layer is in contact with the capping layer and the top surface of the wavelength conversion layer has the emboss pattern formed thereon.

8. The backlight unit of claim 6, wherein a thickness of the low-refractive layer and a thickness of the capping layer are substantially uniform, and
wherein each of the thickness of the low-refractive layer and the thickness of the capping layer is less than or equal to about 1.0 um.

9. The backlight unit of claim 1, wherein a horizontal spacing distance between the second peak portion and the third peak portion is greater than or equal to three times a vertical shortest distance between the second peak portion and the first valley portion.

10. The backlight unit of claim 1, wherein a shortest vertical distance between the first peak portion and the first valley portion ranges from about 1.0 μm to about 10.0 μm.

11. The backlight unit of claim 1, wherein the peak portions are spaced apart from one another in both the first direction and the second direction and the peak portions are arranged in a matrix, and
wherein the valley portions are spaced apart from one another in both the first direction and the second direction and the valley portions are arranged in a matrix.

12. The backlight unit of claim 11, wherein the plurality of peak portions further comprises a fourth peak portion proximate to the second peak portion in the second direction and proximate to the third peak portion in the first direction, and
wherein the first valley portion is disposed between the first peak portion and the fourth peak portion.

13. The backlight unit of claim 11, wherein the light guide plate is bent along a bending direction that intercepts a plane of the first direction and the second direction.

14. The backlight unit of claim 13, further comprising:
a light source unit disposed on a side of the light guide plate in a direction perpendicular to the bending direction.

15. The backlight unit of claim 1, wherein the emboss pattern comprises:
a linear first emboss pattern forming the first peak portion,
a linear second emboss pattern forming the second peak portion, and
a linear third emboss pattern forming the third peak portion,
wherein the linear first emboss pattern, the linear second emboss pattern and the linear third emboss pattern are each extended primarily in the second direction and each have a shape of a wave propagating in the first direction.

16. The backlight unit of claim 15, wherein:
the first emboss pattern is disposed between the second peak portion of the second emboss pattern and the third peak portion of the third emboss pattern;
the first valley portion is disposed between the first emboss pattern and the second peak portion; and
a second valley portion is disposed between the first emboss pattern and the third peak portion.

17. The backlight unit of claim 15, wherein the first emboss pattern and the second emboss pattern at least partially overlap with each other in the second direction.

18. The backlight unit of claim 15, wherein the light guide plate is bent along the first direction.

19. The backlight unit of claim 1, wherein the light guide plate comprises:
a first area having a first radius of curvature; and
a second area having a second radius of curvature that is larger than the first radius of curvature,
wherein a size of the emboss pattern in the first area is larger than a size of the emboss pattern in the second area.

20. A display device comprising:
a light guide plate;
a wavelength conversion layer disposed on a surface of the light guide plate and configured to convert a color of incident light, the wavelength conversion layer comprising an emboss pattern having a plurality of peak portions and a plurality of valley portions; and
a display panel disposed on the wavelength conversion layer,
wherein the plurality of peak portions comprises:
a first peak portion;
a second peak portion proximate to the first peak portion in a first direction; and
a third peak portion proximate to the first peak portion in a second direction,
wherein the plurality of valley portions comprises a first valley portion disposed between the second peak portion and the third peak portion.
